(19) United States
(12) Patent Application Publication
(10) Pub. No.: US 2019/0256690 A1
(43) Pub. Date: Aug. 22, 2019

(54) Rubber Composition

(71) Applicants: Mindaugas RACKAITIS, Massillon, OH (US); Bridgestone Corporation, Chuo-ku (JP)

(72) Inventors: Masahiro Kawashima, Kodaira-shi (JP); Mindaugas Rackaitis, Hudson, OH (US)

(73) Assignee: Bridgestone Corporation, Chuo-ku (JP)

(21) Appl. No.: 16/307,756

(22) PCT Filed: Jun. 8, 2017
(86) PCT No.: PCT/US2017/036504

§ 371 Date: Dec. 6, 2018

Related U.S. Application Data
(60) Provisional application No. 62/347,388, filed on Jun. 8, 2016.

(51) Int. Cl. C08L 7/00; B60C 1/00; B60C 11/00

(52) U.S. Cl. CPC C08L 7/00; B60C 1/0016; C08L 2205/08; C08L 2205/03; C08L 2207/04; B60C 11/0008

(57) ABSTRACT

Specific types of block interpolymers can aid in compatibilizing otherwise incompatible elastomers. Each block of the interpolymer is generally compatible, even miscible, with each of the elastomers. The composition includes a sufficient amount of the block interpolymer such that that the level of immiscibility of the composition is decreased, as evidenced by smaller domains of one elastomer in the other.

### CROSS-REFERENCE TO RELATED APPLICATION

Not applicable.

### BACKGROUND INFORMATION

Rubber goods such as tire treads often are made from elastomeric compositions that contain one or more reinforcing materials such as, for example, particulate carbon black and silica; see, e.g., The Vanderbilt Rubber Handbook, 13th ed. (1990), pp. 603-04.

Good traction and resistance to abrasion are primary considerations for tire treads; however, motor vehicle fuel efficiency concerns argue for a minimization in their rolling resistance, which correlates with a reduction in hysteresis and heat build-up during operation of the tire. These considerations are, to a great extent, competing and somewhat contradictory: treads made from compositions designed to provide good road traction usually exhibit increased rolling resistance and vice versa.

Filler(s), polymer(s), and additives typically are chosen so as to provide an acceptable compromise or balance of these properties. Ensuring that reinforcing filler(s) are well dispersed throughout the elastomeric material(s) both enhances processability and acts to improve physical properties. Dispersion of fillers can be improved by increasing their interaction with the elastomer(s). Examples of efforts of this type include high temperature mixing in the presence of selectively reactive promoters, surface oxidation of compounding materials, surface grafting, and chemically modifying the polymer, typically at a terminus thereof.

Various elastomeric materials often are used in the manufacture of vulcanizates such as, e.g., tire components. In addition to natural rubber, some of the most commonly employed include high-cis polybutadiene, often made by processes employing catalysts, and substantially random styrene/butadiene interpolymers, often made by processes employing anionic initiators. Functionalities that can be incorporated into high-cis polybutadiene often cannot be incorporated into anionically initiated styrene/butadiene interpolymers and vice versa.

Certain of the elastomeric materials used in the manufacture of vulcanizates are known to be immiscible. For example, natural rubber is immiscible with many synthetic polymers; see, e.g., S. Thomas et al. (eds.), Natural Rubber Materials: Vol. 1: Blends and IPNs, (Royal Society of Chemistry, 2013). Poly(butadiene) also is immiscible with poly(isoprene).

Some immiscible elastomers can have their immiscibility somewhat mitigated by extraordinary physical manipulation (i.e., homogenization) techniques; see, for example, the compression technique described in T. Hashimoto et al., “Homogenization of Immiscible Rubber/Rubber Polymer Mixtures by Uniaxial Compression,” Macromolecules, 1989, pp. 2293-2302 (American Chemical Society; Washington, D.C.). For present purposes, elastomers that are not miscible using standard mixing (physical blending) techniques are considered to be immiscible.

In instances where a rubber composition containing (normally) incompatible polymers is desired, a compatibilizing polymer often is used. Many such compatibilizers are A-B block copolymers where the A block is preferentially miscible with one of the incompatible polymers and the B block is preferentially miscible with the other. For example, U.S. Pat. No. 6,313,213 teaches compatibilization of a rubber composition that includes 60-90 parts by weight (pbw) of natural rubber and/or polyisoprene and 10-35 pbw high-cis polybutadiene using up to 5 pbw of an A-B block copolymer where the A block is a poly(butadiene) or poly(styrene-butadiene) and the B block is a polyisoprene.

Any such compatibilizer where one portion is miscible with one component elastomer and another portion is miscible with another component polymer introduces compromises into the rubber composition. A compatibilizer block interpolymer that avoids or reduces such compromises remains desirable, specifically, one that provides significant reductions in interfacial energy and very small elastomer-in-elastomer domains.

### SUMMARY

Specific types of block interpolymers, preferably copolymers, can be used to compatibilize otherwise incompatible elastomers.

In one aspect is provided a composition that includes at least two elastomers, immiscible with each other, as well as a block interpolymer. Each block of the interpolymer is generally compatible, even miscible, with each of the elastomers. The composition includes a sufficient amount of the block interpolymer such that that the level of immiscibility of the composition is decreased as evidenced by smaller domains (i.e., domains having reduced diameters) of one elastomer in the other.

In a related aspect is provided a method of enhancing the miscibility of a composition by adding a sufficient amount of the aforedescribed block interpolymer to an immiscible blend of at least two elastomers.

The foregoing compositions generally include two elastomers, and the block interpolymer generally is an elastomeric copolymer, each block of which includes unsaturated mer.

One or more particulate fillers can be added to the foregoing compositions.

The foregoing compositions can be used to provide vulcanizates, particularly but not exclusively tire components.

Other aspects of the present invention will be apparent to the ordinarily skilled artisan from the detailed description that follows. To assist in understanding that description of various embodiments, certain definitions (which are intended to apply throughout unless the surrounding text explicitly indicates a contrary intention) are provided immediately below:

“comprising” means including but not limited to those ingredients or steps which follow the term;

“consists” or “consisting of” means including only those ingredients or steps which follow the term as well as minor amounts of inactive additives or adjuvants or, in the case of processes, standard isolation, purification and processing steps;

“mer” or “mer unit” means that portion of a polymer derived from a single reactant molecule (e.g., ethylene mer has the general formula —CH₂CH₂—);

“copolymer” means a polymer that includes mer units derived from two reactants, typically monomers, and is inclusive of random, block, segmented, graft, etc., copolymers;

“interpolymer” means a polymer that includes mer units derived from at least two reactants, typically monomers, and is inclusive of copolymers, terpolymers, tetrapolymers, and the like;

“polyene” means a molecule with at least two double bonds located in the longest portion or chain thereof, and specifically is inclusive of dienes, trienes, and the like;

“elastomer” means a vulcanizable polymer that contains at least some mer derived from a polyene;

“natural rubber” means an elastomer isolated from a botanical-origin latex;

“butyl rubber” means a copolymer of isobutylene and a minor amount of isoprene;

“halogenated butyl rubber” means a butyl rubber in which an average of one H atom per mer has been replaced by a halogen atom, typically Br or Cl;

“EPDM” means an interpolymer of ethylene, propylene, and one or more non-conjugated dienes where the remaining unsaturation after polymerization is present in a side chain of the interpolymer;

“high cis poly(butadiene)” means an elastomer consisting of butadiene mer, wherein at least 90 mole percent of the butadiene mer is present in a cis configuration and no more than 5 mole percent of the butadiene mer is present in a vinyl configuration;

“low cis poly(butadiene)” means an elastomer consisting of butadiene mer, wherein no more than 40 mole percent of the butadiene mer is present in a cis configuration and at least 5 mole percent of that butadiene mer is present in a vinyl configuration;

“high vinyl poly(butadiene)” means an elastomer consisting of butadiene mer, wherein at least 50 mole percent of that butadiene mer is present in a vinyl configuration;

“low vinyl poly(butadiene)” means an elastomer consisting of butadiene mer, wherein no more than 20 mole percent of that butadiene mer is present in a vinyl configuration;

“radical” means the portion of a molecule that remains after reacting with another molecule, regardless of whether any atoms are gained or lost as a result of the reaction;

“drop temperature” is a prescribed upper temperature at which a filled rubber composition (vulcanizate) is evacuated from mixing equipment (e.g., a Banbury mixer) to a mill for being worked into sheets;

“Mooney viscosity” is an arbitrary 0-100 scale representation of the resistance to flow of an uncured or partially cured polymer, typically an elastomer, determined by measuring the amount of torque required to rotate an embedded cylindrical metal (optionally knurled) disk or rotor in a cylindrical (optionally serrated) cavity at a defined temperature, disc size, and time to reach equilibrium;

“gum Mooney viscosity” is the Mooney viscosity of an uncured polymer prior to addition of any filler(s);

“compound Mooney viscosity” is the Mooney viscosity of a composition that includes, inter alia, an uncured or partially cured polymer and particulate filler(s); and

“phr” means pbw per 100 pbw rubber.

### DETAILED DESCRIPTION

As apparent from the preceding section, the composition includes two or more elastomers that, if merely blended, are immiscible using standard processing techniques. Immiscibility in general, as well as comparisons of degrees of immiscibility as evidenced by size of domains of one elastomer in the other, can be determined using, for example, a microscopy technique such as transmission electron microscope (TEM) or scanning electron microscope (SEM) or perhaps a light scattering technique.

Examples of elastomers that can be employed in the composition include, but are not limited to, natural rubber, poly(isoprene), poly(butadiene), styrene/butadiene interpolymer, EPDM, butyl rubber and halogenated butyl (halobutyl) rubber. While some of these elastomers such as, for example, poly(butadiene) and a styrene/butadiene interpolymer (particularly one with a low amount of styrene mer), can display sufficient miscibility so as to not require a compatibilizer, others such as EPDM and halobutyl rubber generally are considered immiscible with all of the others.

Where a composition is a blend of two elastomers, the weight ratio of the two polymers can range from 5:95 to 95:5, generally from 10:90 to 90:10, and typically from 15:85 to 85:15. Where a composition is blend of more than two elastomers, at least 5% (w/w) of each elastomer is present, while no single elastomer represents more than 90% (w/w) of the composition.

The size (i.e., molecular weight) and microstructure of the component elastomers are not believed to be particularly important in terms of practice and efficacy of the described methods. In general, the number average molecular weight (Mₙ) of a synthetic elastomer employed as a composition component is such that a quenched sample exhibits a gum Mooney viscosity (ML₄/100° C.) of from ˜2 to ˜150, more commonly from ˜2.5 to ˜125, even more commonly from ˜5 to ˜100, and most commonly from ˜10 to ˜75. Exemplary Mₙ values range from ˜5000 to ˜200,000, commonly from ˜25,000 to ˜150,000, and typically from ˜50,000 to ˜125,000. (Both Mₙ and M_{w} can be determined by GPC using polystyrene standards for calibration and appropriate Mark-Houwink constants.)

Proper selection of two elastomers in conjunction with tailoring the proportion of the elastomer components can provide an immense palette of desirable composition properties and characteristics, so compositions which contain just two immiscible elastomers constitute a preferred subset. Nevertheless, compositions with three, four or even more elastomers are contemplated; where a composition includes more than two elastomers, each of the component elastomers can exhibit different degrees of miscibility with the other elastomers.

For tire component applications, a composition of particular interest includes a poly(isoprene), either synthetic or in natural rubber, with a poly(butadiene) such as a high cis- or high vinyl-poly(butadiene).

Also included in the composition is a block interpolymer, each block of which is miscible with one or more of the elastomers in the composition. In situations where the composition includes two immiscible elastomers, the block interpolymer can be a block copolymer.

The size (i.e., molecular weight) and microstructure of the component elastomers can vary widely. In general, exemplary weight average molecular weights (M_{w}) for potentially useful block interpolymers range from ˜30,000 to ˜1,000,000, commonly from ˜35,000 to ˜750,000, more commonly from ˜40,000 to ˜600,000, typically from ˜45,000 to ˜550,000, and most typically from ˜50,000 to ˜500,000.

Where the block interpolymer is a copolymer, the weight ratio of the two blocks can range from 5:95 to 95:5, generally from 10:90 to 90:10, and typically from 20:80 to 80:20. Where a block interpolymer has more than two blocks, each block constitutes at least 5% (w/w) of the overall interpolymer, while no single block represents more than 90% (w/w).

Block interpolymers can have at least one glass transition temperature (T_{g}) or point in the range of −150° to 50° C. Often, the block interpolymer has two glass transition temperatures in this range. In the case of copolymers, one T_{g} often is in the range of −100° to −50° C., commonly from −90° to −60° C., and the other in the range of −50° to 5° C., commonly from −30° to 0° C.

Block interpolymers can be made by a variety of polymerization techniques (e.g., emulsion, solution, etc.), using one or more initiators and/or catalysts to provide the various blocks. The ordinarily skilled artisan is familiar with laboratory, pilot plant and commercial scale reaction conditions necessary to make and process such block interpolymers and, accordingly, a detailed description of such techniques and conditions are not provided here. For an overview of such details, the interested reader is directed to any of a variety of resources such as, for example, I. W. Hamley (ed.), Developments in Block Copolymer Science and Technology (John Wiley & Sons Ltd., 2004).

In some embodiments, each block of the block interpolymer includes unsaturated mer, i.e., the block interpolymer is elastomeric.

A block interpolymer of particular interest due to its compatibility with a broad spectrum of elastomers is an A-B block copolymer in which the A block is a low-vinyl poly(butadiene) and the B block is high-vinyl poly(butadiene). Each of the blocks exhibits good interactivity with (i.e., enhances the miscibility of) a variety of elastomers, with the A block being particularly compatible with natural rubber and poly(isoprene), while the B block is particularly compatible with many polybutadienes. This type of block copolymer generally has the molecular weight and molar ratio characteristics described above.

If the sum of the elastomer components of the composition are deemed to be 100 pbw, the amount of block interpolymer employed can range from more than zero up to ˜25 phr, generally from 2.5 to 22.5 phr, commonly from 5 to 20 phr, and typically from 7.5 to 17.5 phr. Unless the block interpolymer itself provides desirable properties to, or desirably impacts the properties of, the composition, the lowest possible amount of block interpolymer is added to achieve the necessary or desired amount of immiscibility reduction.

Adding a compatibilizing block copolymer to an elastomer generally does not impact the T_{g} of the elastomer, although the block copolymer can exhibit a slight T_{g} shift.

Advantageously, the miscibility provided to the composition by the presence of the block interpolymer is not negatively affected by incorporation of particulate fillers into the composition.

Rubber compositions typically are filled to a volume fraction, which is the total volume of filler(s) added divided by the total volume of the elastomeric stock, of ˜25%; accordingly, typical (combined) amounts of reinforcing fillers is ˜30 to 100 phr.

One class of useful particulate fillers is carbon black.

Potentially useful carbon black materials include, but not limited to, furnace blacks, channel blacks and lamp blacks. More specifically, examples of the carbon blacks include super abrasion furnace blacks, high abrasion furnace blacks, fast extrusion furnace blacks, fine furnace blacks, intermediate super abrasion furnace blacks, semi-reinforcing furnace blacks, medium processing channel blacks, hard processing channel blacks, conducting channel blacks, and acetylene blacks; mixtures of two or more of these can be used. Carbon blacks having a surface area (EMSA) of at least 20 m²/g, preferably at least ˜35 m²/g, are preferred; surface area values can be determined by ASTM D-1765. The carbon blacks may be in pelletized form or an unpelletized flocculent mass, although unpelletized carbon black can be preferred for use in certain mixers.

The amount of carbon black utilized can be been up to ˜50 phr, with ˜5 to ˜40 phr being typical. For certain oil-extended formulations, the amount of carbon black has been even higher, e.g., on the order of ˜80 phr.

Amorphous silica (SiO₂) also commonly is used as a filler. Silicas typically are produced by a chemical reaction in water, from which they are precipitated as ultrafine, spherical particles which strongly associate into aggregates and, in turn, combine less strongly into agglomerates. Surface area gives a reliable measure of the reinforcing character of different silicas, with BET (see; Brunauer et al., J. Am. Chem. Soc., vol. 60, p. 309 et seq.) surface areas of less than 450 m²/g, commonly between ˜32 to ˜400 m²/g, and typically ˜100 to ˜250 m²/g, generally being considered useful. Commercial suppliers of silica include PPG Industries, Inc. (Pittsburgh, Pa.), Grace Davison (Baltimore, Md.), Degussa Corp. (Parsippany, N.J.), Rhodia Silica Systems (Cranbury, N.J.), and J.M. Huber Corp. (Edison, N.J.).

When silica is employed as a reinforcing filler, addition of a coupling agent such as a silane is customary so as to ensure good mixing in, and interaction with, the elastomer(s). Generally, the amount of silane that is added ranges between ˜4 and 20%, based on the weight of silica filler present in the compound. Coupling agents generally include a functional group capable of bonding physically and/or chemically with a group on the surface of the silica filler (e.g., surface silanol groups), a hydrocarbon group linkage, and a functional group capable of bonding with the elastomer (e.g., via a sulfur-containing linkage). Such coupling agents include organosilanes, in particular polysulfurized alkoxysilanes (see, e.g., U.S. Pat. Nos. 3,873,489, 3,978,103, 3,997,581, 4,002,594, 5,580,919, 5,583,245, 5,663,396, 5,684,171, 5,684,172, 5,696,197, etc.) or polyorganosiloxanes with the appropriate types of functional groups. Addition of a processing aid can be used to reduce the amount of silane employed; see, e.g., U.S. Pat. No. 6,525,118 for a description of fatty acid esters of sugars used as processing aids.

Silica commonly is employed in amounts of up to ˜100 phr, typically from ˜5 to ˜80 phr. The useful upper range is limited by the high viscosity that such fillers can impart. When carbon black also is used, the amount of silica can be decreased to as low as ˜1 phr; as the amount of silica decreases, lesser amounts of the processing aids, plus silane if any, can be employed.

Additional fillers useful as processing aids include mineral fillers, such as clay (hydrous aluminum silicate), talc (hydrous magnesium silicate), and mica as well as non-mineral fillers such as urea and sodium sulfate. Preferred micas contain principally alumina, silica and potash, although other variants also can be useful. The additional fillers can be utilized in an amount of up to about 40 phr, typically up to about 20 phr.

Coupling agents are compounds which include a functional group capable of bonding physically and/or chemically with a group on the surface of the silica filler (e.g., surface silanol groups) and a functional group capable of bonding with the elastomer (e.g., via a sulfur-containing linkage). Such coupling agents include organosilanes, in particular polysulfurized alkoxysilanes (see, e.g., U.S. Pat. Nos. 3,873,489, 3,978,103, 3,997,581, 4,002,594, 5,580,919, 5,583,245, 5,663,396, 5,684,171, 5,684,172, 5,696,197, etc.) or polyorganosiloxanes bearing the types of functionalities mentioned above. An exemplary coupling agent is bis[3-(triethoxysilyl)-propyl]tetrasulfide.

Addition of a processing aid can be used to reduce the amount of silane employed. See, e.g., U.S. Pat. No. 6,525,118 for a description of fatty acid esters of sugars used as processing aids. Additional fillers useful as processing aids include, but are not limited to, mineral fillers, such as clay (hydrous aluminum silicate), talc (hydrous magnesium silicate), and mica as well as non-mineral fillers such as urea and sodium sulfate. Preferred micas contain principally alumina, silica and potash, although other variants also can be useful. The additional fillers can be utilized in an amount of up to ˜40 phr, typically up to ˜20 phr.

One or more non-conventional fillers having relatively high interfacial free energies, i.e., surface free energy in water values (γₚₗ) can be used in conjunction with or in place of carbon black and/or silica. The term “relatively high” can be defined or characterized in a variety of ways such as, e.g., greater than that of the water-air interface, preferably several multiples (e.g., at least 2×, at least 3× or even at least 4×) of this value; at least several multiples (e.g., at least 2×, at least 3×, at least 4×, at least 5×, at least 6×, at least 7×, at least 8×, at least 9× or even at least 10×) of the γₚₗ value for amorphous silica; in absolute terms such as, e.g., at least ˜300, at least ˜400, at least ˜500, at least ˜600, at least ˜700, at least ˜750, at least ˜1000, at least ˜1500, and at least ˜2000 mJ/m², and various combinations of the foregoing minimum values.

Non-limiting examples of naturally occurring materials with relatively high interfacial free energies include F-apatite, goethite, hematite, zincite, tenorite, gibbsite, quartz, kaolinite, all forms of pyrite, and the like. Certain synthetic complex oxides also can exhibit this type of high interfacial free energy.

The foregoing types of materials typically are more dense than either carbon black or amorphous silica; thus, replacing a particular mass of carbon black or silica with an equal mass of a non-conventional filler typically will result in a much smaller volume of overall filler being present in a given compound. Accordingly, replacement typically is made on an equal volume, as opposed to equal weight, basis.

Generally, ˜5 to ˜60% of one or more conventional particulate filler materials can be replaced with an approximately equivalent (˜0.8× to ˜1.2×) volume of non-conventional filler particles. In certain embodiments, replacing ˜10 to ˜58% of the conventional particulate filler material(s) with an approximately equivalent (˜0.85× to ˜1.15×) volume of other filler particles is sufficient while, in other embodiments, replacing ˜15 to ˜55% of the conventional particulate filler material(s) with an approximately equivalent (˜0.9× to ˜1.1×) volume of other filler particles is adequate.

Non-conventional filler particles generally can be of approximately the same size as the conventional fillers employed in compounds.

Other conventional rubber additives also can be added. These include, for example, process oils, plasticizers, anti-degradants such as antioxidants and antiozonants, curing agents and the like.

All ingredients can be mixed using standard equipment such as, e.g., Banbury or Brabender mixers. Typically, mixing occurs in two or more stages. During the first stage (often referred to as the masterbatch stage), mixing typically is begun at temperatures of 120° to 130° C. and increases until a so-called drop temperature, typically somewhere near 165° C., is reached.

Where a formulation includes silica, a separate re-mill stage often is employed for separate addition of the silane component(s). This stage often is performed at temperatures similar to, although often slightly lower than, those employed in the masterbatch stage, i.e., ramping from ˜90° C. to a drop temperature of ˜150° C.

Reinforced rubber compounds conventionally are cured with ˜0.2 to ˜5 phr of one or more known vulcanizing agents such as, for example, sulfur or peroxide-based curing systems. For a general disclosure of suitable vulcanizing agents, the interested reader is directed to an overview such as that provided in Kirk-Othmer, Encyclopedia of Chem. Tech., 3d ed., (Wiley Interscience, New York, 1982), vol. 20, pp. 365-468. Vulcanizing agents, accelerators, etc., are added at a final mixing stage. To ensure that onset of vulcanization does not occur prematurely, this mixing step often is done at lower temperatures, e.g., starting at ˜60° to ˜65° C. and not going higher than ˜105° to ˜110° C.

Subsequently, the compounded mixture is processed (e.g., milled) into sheets prior to being formed into any of a variety of components and then vulcanized, which typically occurs at ˜5° to ˜15° C. higher than the highest temperatures employed during the mixing stages, most commonly ˜170° C.

All values given in the form of percentages hereinthroughout are weight percentages unless the surrounding text explicitly indicates a contrary intention.

The T_{g} of a polymer can be determined by heat capacity measurements using a properly calibrated DSC unit, scanning over an appropriate temperature range, or by a viscoelastic technique, e.g., evaluating the temperature dependence of G″.

All patents and published patent applications mentioned previously are incorporated herein by reference.

Various embodiments of the present invention have been provided by way of example and not limitation. As evident from the foregoing description, general preferences regarding features, ranges, numerical limitations and embodiments are to the extent feasible, as long as not interfering or incompatible, envisioned as being capable of being combined with other such generally preferred features, ranges, numerical limitations and embodiments.

The following non-limiting, illustrative examples provide details regarding exemplary conditions and materials that can be useful in the practice of the present invention.

### EXAMPLES

### Examples 1-8: Polybutadiene Syntheses

A two-step polymerization process was used to prepare six block copolymers having one block of low vinyl poly(butadiene) and one block of high vinyl poly(butadiene), abbreviated LVB-b-HVB below. A batch polymerization at 50° C. using n-butyllithium as initiator was used to prepare a living LVB block, followed by a continuous process over 12+ hours at 25° C. employing 1,2-dipiperidino ethane to add a HVB block.

As comparatives, the foregoing polymerization processes were used, individually, to prepare low- and high-vinyl comparative homopolymers. These are designated Samples 1 and 2, respectively, below.

The vinyl content, molecular weights and T_{g} of each polymer are summarized below in Table 1.

TABLE 1
Polymer properties

| | 1 | 2 | | | | | | |
|---|---|---|---|---|---|---|---|---|
| | (comp.) | (comp.) | 3 | 4 | 5 | 6 | 7 | 8 |
| Targets | LVB | HVB | ← LVB-b-HVB → | | | | | |
| vinyl (%) | 10 | 90 | 70 | 90 | 90 | 90 | 90 | 90 |
| Mₙ | 80 | 80 | 150 | 80 | 150 | 300 | 150 | 150 |
| LVB:HVB | 100:0 | 0:100 | 50:50 | 50:50 | 50:50 | 50:50 | 80:20 | 20:80 |
| vinyl, overall (%) | 8.1 | 91.1 | 41.3 | 47.8 | 48.3 | 48.1 | 24.3 | 74.5 |
| vinyl, HVB (%) | 0 | 91.1 | 74.5 | 87.5 | 88.5 | 88.1 | 89.1 | 91.1 |
| Mₙ | 78 | 65 | 127 | 77 | 128 | 283 | 129 | 126 |
| M_{w} | 82 | 67 | 133 | 80 | 135 | 303 | 136 | 131 |
| Mₚ | 84 | 69 | 135 | 81 | 138 | 315 | 137 | 132 |
| T_{g} (° C.) | −95 | −7 | −78 | −78 | −82 | −93, −11 | −91 | −30 |

### Examples 9-16: Compositions and Vulcanizates

Testing below was performed on filled compositions made according to the formulations shown in Table 2 in which the amounts of the elastomeric components are given in pbw, while the amounts of the other ingredients are given in phr. The entirety of each masterbatch was used in the final mixing step, where N-(1,3-dimethylbutyl)-N′-phenyl-p-phenylenediamine acts as an antioxidant while N-cyclohexyl-2-benzothiazolesulfenamide acts as an accelerator.

(This formulation is used to permit evaluation of functionalized polymers with a specific particulate filler, but this should not be considered limiting because mixtures of carbon black and silica, as well as the presence of additional types of particulate fillers, are envisioned, as set forth above in the Detailed Description.)

TABLE 2
Composition formulation, carbon black filler

| | Amount |
|---|---|
| Masterbatch | |
| natural rubber | 60 |
| high cis poly(butadiene) | 30-40* |
| polymers from Examples 1-8 | 5-10* |
| carbon black (N220 type) | 44 |
| wax | 1 |
| stearic acid | 2 |
| ZnO | 1 |
| Final | |
| sulfur | 1.8 |
| ZnO | 2.5 |
| N-(1,3-dimethylbutyl)-N′-phenyl-p-phenylenediamine | 1 |
| N-cyclohexyl-2-benzothiazolesulfenamide | 2 |
| TOTAL | 155.3 |

*varied, with amount used in each composition shown below in Table 3

The physical, viscoelastic and wear properties of the prepared compositions and vulcanizates provided therefrom are summarized below in Table 3.

Tensile mechanical properties were determined using the standard procedure described in ASTM-D412; Payne effect (AG′, i.e., the difference between G′ at low and high strain values) and hysteresis (tan δ) data were obtained from dynamic experiments conducted at 60° C. and 15 Hz, from 0.1% to 20% strain. With respect to tensile properties, M₃₀₀ is modulus at 300% elongation, T_{b} is tensile strength at break, and E_{b} is percent elongation at break. Wear rate is measured using a Lambourn abrasion tester, with wear index values representing the value obtained by dividing wear rate of the control, i.e., composition containing no compatibilizing polymer by wear rate of a tested sample and multiplying that quotient by 100.

TABLE 3
Composition and vulcanizate properties

| | 9 | 10 | | | | | | |
|---|---|---|---|---|---|---|---|---|
| | (control) | (comp.) | 11 | 12 | 13 | 14 | 15 | 16 |
| high cis PBD (pbw) | 40 | 30 | 30 | 30 | 30 | 30 | 30 | 30 |
| synthetic polymer | — | 1 & 2 | 3 | 4 | 5 | 6 | 7 | 8 |
| amount (pbw) | 0 | 5 + 5 | 10 | 10 | 10 | 10 | 10 | 10 |
| T_{b} (MPa) | 18.0 | 20.5 | 21.5 | 20.0 | 20.0 | 19.6 | 17.2 | 20.6 |
| E_{b} (%) | 300.2 | 350.8 | 370.8 | 356.6 | 343.8 | 338.1 | 289.6 | 335.3 |
| M₃₀₀ (MPa) | 17.8 | 16.8 | 16.4 | 16.2 | 16.9 | 16.9 | 17.2 | 17.9 |
| fracture toughness | 25.2 | 31.0 | 34.2 | 30.9 | 29.6 | 28.3 | 23.0 | 32.2 |
| (MPa · m^{1/2}) | | | | | | | | |
| tan δ @ 60° C. | 0.13 | 0.13 | 0.13 | 0.16 | 0.14 | 0.13 | 0.13 | 0.14 |
| ΔG′ (MPa) | 1.89 | 1.46 | 1.43 | 2.13 | 1.95 | 1.68 | 1.85 | 2.04 |
| wear rate (mg/m) | 0.105 | 0.104 | 0.103 | 0.089 | 0.088 | 0.093 | 0.102 | 0.095 |
| wear index | 100 | 101 | 102 | 118 | 119 | 113 | 103 | 111 |

From the data of Table 3, particularly the wear rate data and wear index values, one can see that inventive compositions provide vulcanizates with desirable properties.

TEM scans of the compositions showed significant reductions in the sizes of immiscible domains of poly(butadiene) in natural rubber.

1. A composition, comprising:
a) a plurality of elastomers, each elastomer in said plurality of elastomers being immiscible with every other elastomer in said plurality of elastomers, and
b) a block interpolymer, each block of said interpolymer being miscible with each elastomer in said plurality of elastomers,
said block interpolymer being present in an amount sufficient so as to reduce the immiscibility of said elastomers as determined by elastomer-in-elastomer domain size.

2. The composition of claim 1 wherein said plurality of elastomers consists of two immiscible elastomers.

3. The composition of claim 2 wherein said block interpolymer consists of two blocks.

4. The composition of claim 2 wherein said two immiscible elastomers are a poly(isoprene) and a poly(butadiene).

5. The composition of claim 3 wherein the weight ratio of blocks is from 5:95 to 95:5.

6. The composition of claim 3 wherein a first block of said block interpolymer is a low vinyl poly(butadiene) and a second block of said block interpolymer is a high vinyl poly(butadiene).

7. The composition of claim 6 wherein said first block includes no more than 20% of its butadiene mer in a vinyl configuration.

8. The composition of claim 6 wherein said second block includes at least 50% of its butadiene mer in a vinyl configuration.

9. The composition of claim 1 wherein said block interpolymer has a weight average molecular weight of from 30,000 to 1,000,000 Daltons.

10. The composition of claim 1 wherein said block interpolymer has at least one glass transition temperature in the range of from −150° to 50° C.

11. The composition of claim 1 wherein said composition comprises from 5 to 20 parts by weight of said block interpolymer per 100 parts by weight of said plurality of elastomers.

12. The composition of claim 1 wherein said plurality of elastomers comprises a poly(isoprene) and a poly(butadiene).

13. The composition of claim 12 wherein a first block of said block interpolymer is a low vinyl poly(butadiene) and a second block of said block interpolymer is a high vinyl poly(butadiene).

14. The composition of claim 13 wherein said first block includes no more than 20% of its butadiene mer in a vinyl configuration.

15. The composition of claim 13 wherein said second block includes at least 50% of its butadiene mer in a vinyl configuration.

16. A method of reducing the immiscibility of elastomers, said method comprising:
a) providing an initial composition that comprises at least two elastomers, each of said elastomers being immiscible with the others, and
b) mixing said initial composition with an effective amount of a block interpolymer, each block of said interpolymer being miscible with each of said at least two elastomers,
thereby providing a second composition, said second composition having reduced immiscibility as determined by elastomer-in-elastomer domain size.

17. The method of claim 16 wherein said effective amount is from 5 to 20 parts by weight based on 100 parts by weight of said initial composition.

18. The method of claim 16 wherein said initial composition consists of two immiscible elastomers and said block interpolymer consists of two blocks.

19. The method of claim 18 wherein said two immiscible elastomers are a poly(isoprene) and a poly(butadiene).

20. The method of claim 18 wherein a first block of said block interpolymer is a low vinyl poly(butadiene) and a second block of said block interpolymer is a high vinyl poly(butadiene).
